(19) United States
(12) Patent Application Publication
(10) Pub. No.: US 2007/0240938 A1
(43) Pub. Date: Oct. 18, 2007

(54) Ladder having improved mobility

(76) Inventors: Brian Andrew Butera, Hawthorn Woods, IL (US); Dane Christopher Butera, Hawthorn Woods, IL (US)

Correspondence Address: Richard A. Sonnentag, 7 North Trail, Hawthorn Woods, IL, 60047, US

(21) Appl. No.: 11/405,173

(22) Filed: Apr. 17, 2006

(51) Int. Cl. E06C 1/00

(52) U.S. Cl. 182/165

(57) ABSTRACT

A ladder includes a first side having a top step and a second side including a set of side rails coupled together. The second side is coupled to the top step of the first side via a hinge arrangement, where the hinge arrangement includes a shaft coupled to the top step of the first side and the set of side rails of the second side. The first side is narrower than the second side.

### FIELD OF THE INVENTION

The invention relates generally to ladders and more specifically to step ladders which are easily moved.

### BACKGROUND OF THE INVENTION

Ladders are well known in the art. One such well known ladder 101 is shown in FIG. 1. As shown in FIG. 1, ladder 100 is an A-frame design having sides 101, 105. Sides 101, 105 include steps 110 and rungs 115, respectively. Sides 101, 105 of the ladder are connected at their tops by a pivotal bracket 120. So that sides 101, 105 of ladder 100 do not collapse when weight is applied to the steps 110 (or in some cases the rungs 115), it is known to further connect sides 101, 105 with a chain 125.

Modifications to ladder 100 are also well known in the prior art. One such modification to ladder 100 well known in the art is to replace chain 125 with a bracket 205. Another well know modification to ladder 100 is to replace the pivotal bracket 120 with a fixed bracket 220. Such a resulting ladder 200 is shown in FIG. 2. In addition to preventing ladder 200 from collapsing, bracket 205 also locks ladder 200 into its A-frame position. When ladder 201 is moved, it retains its A-frame form as shown in FIG. 2. As is well known in the art, bracket 205 must be released to close ladder 201.

One beneficial attribute of a ladder is that it be capable of being easily moved. However, ladders 100, 200 suffer in this respect for several reasons. Referring to FIG. 1, the sides 101, 105 of ladder 100 are equally spaced which prevents ladder 100 from being maneuvered into tight spaces. Referring to FIG. 2, the fixed bracket 220 of ladder 200 is connected to the sides 200, 205 by rivets, or the like, which compress the sides 200, 205 against the bracket 220. Such compression leads to a large amount of friction, which in turn allows ladder 200 to maintain their A-frame position. With this prior art ladder, a force must be exerted on sides 200, 205 just to close ladder 200. As one skilled in the art will appreciate, ladder 200 in the closed position is much easier to move, and thus use, than such a ladder in the open, A-frame position.

Thus a need exists for a ladder having improved mobility.

### BRIEF DESCRIPTION OF THE DRAWINGS

FIG. 1 generally depicts an A-frame ladder having a pivotal bracket and sides connected by a chain as is well known in the art.

FIG. 2 generally depicts an A-frame ladder having a fixed bracket and sides connected by a bracket as is well known in the art.

FIG. 3 generally depicts a ladder having improved mobility in accordance with a preferred embodiment of the invention.

FIG. 4 generally depicts a hinge arrangement which couples a first side of the ladder to second side of the ladder in accordance with the invention.

FIG. 5 generally depicts a side view of a conduit and a shaft of the hinge arrangement in accordance with the invention.

FIG. 6 generally depicts a top view of the hinge arrangement when completely configured in accordance with the invention.

FIG. 7 generally depicts a ladder having improved mobility in accordance with an alternate embodiment of the invention.

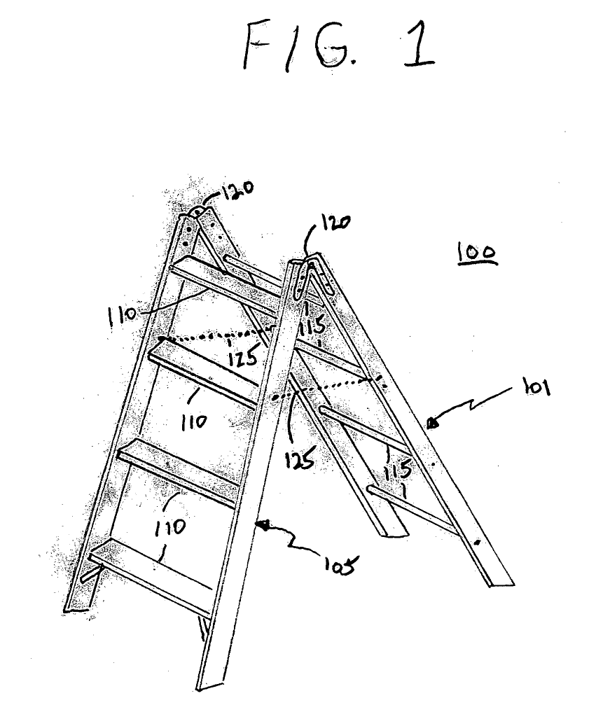

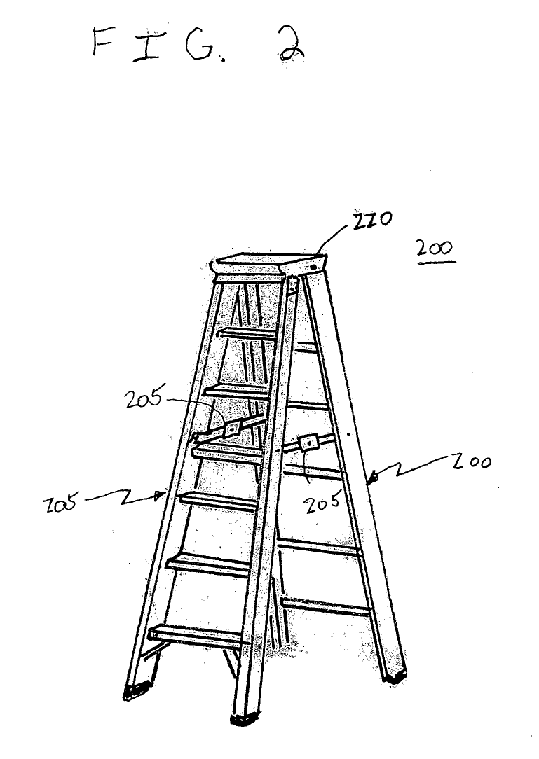

### DETAILED DESCRIPTION OF THE DRAWINGS

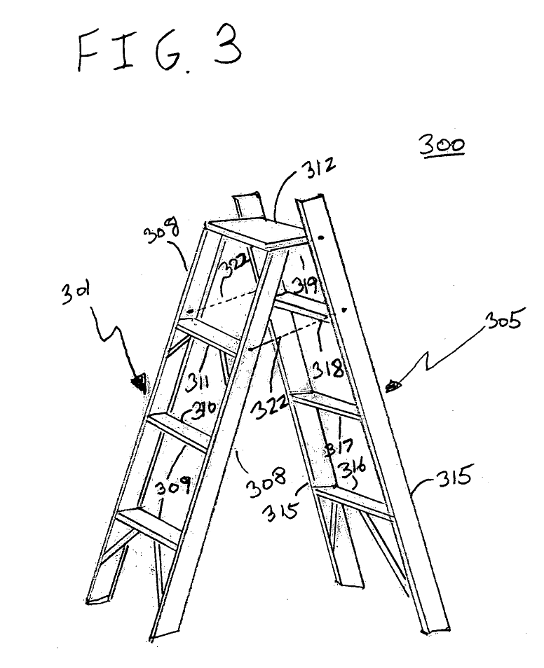

FIG. 3 generally depicts a ladder 300 having improved mobility in accordance with a preferred embodiment of the invention. As shown in FIG. 3, a first side 301 includes a set of side rails 308. In the preferred embodiment, the set of side rails 308 are coupled together via steps 309-311. As one skilled in the art will appreciate, the set of side rails 308 could likewise be coupled together via rungs or the like. A top step 312 is also coupled to the first side 301. In the preferred embodiment, the top step 312 is coupled to the first side 301 by being securely attached to the set of side rails 308 via rivets or the like. As one skilled in the art will appreciate, other configurations and/or means other than rivets could be used to secure the top step 312 to the first side 301.

Also shown in FIG. 3 is a second side 305 of ladder 300. Second side 305 includes a set of side rails 315. As with first side 301, the set of side rails 315 are coupled together via steps 316-319. Again, as one skilled in the art will appreciate, the set of side rails 315 could likewise be coupled together via rungs or the like. In the preferred embodiment, two (2) chains 322 are used to provide support between sides 301, 305 when the weight of a user is applied to ladder 300. Chains 322 could be replaced with a single chain (not shown) without departing from the spirit and scope of the invention. As an exemplary embodiment, a single chain could be attached at to steps 311 and 318 to provide support between sides 301, 305 when the weight of a user is applied to ladder 300.

Prior art ladders include sides which are of equal width. In accordance with the invention, side 301 of ladder 300 is narrower than side 305. This feature contributes to the improved mobility of ladder 300 when compared to prior art ladders (such as ladders 101, 201) because side 301 can be moved in smaller, tighter areas. Since side 305 provides a wider width, ladder 300 does not suffer from a loss of stability. While ladder 300 includes side 301 having four (4) steps 309-311 and top step 312 and side 305 having four (4) steps 316-319, the number of steps can be varied without deviating from the spirit and scope of the invention.

As also shown in FIG. 3, side 305 is higher than side 301. More specifically, set of side rails 315 are extended beyond the height of top step 312. This extension provides several advantages in accordance with the invention. A first advantage is that ladder 300 can be used as a scaffolding base. When a plank or the like (not shown) is placed on top step 312 in a scaffolding configuration, the plank or the like will be prevented from slipping off of ladder 300 by extended side rails 315. Another advantage of extended side rails 315 is that a paint can or other tools that have a handle or a hook arrangement (not shown) can be placed over one of extended side rails 315. In accordance with the improved mobility aspects of the present invention, ladder 300 can be folded with the paint can or other tools supported by one of extended side rails 315. Use of one of extended side rails 315 in this manner can save significant time during projects or use that requires movement of not only ladder 300, but also such paint cans or other tools. While the use of one of extended side rails 315 has been described in the preferred embodiment, one skilled in the art will appreciate that both extended side rails 315 could be beneficially employed to realize the above benefits in accordance with the invention.

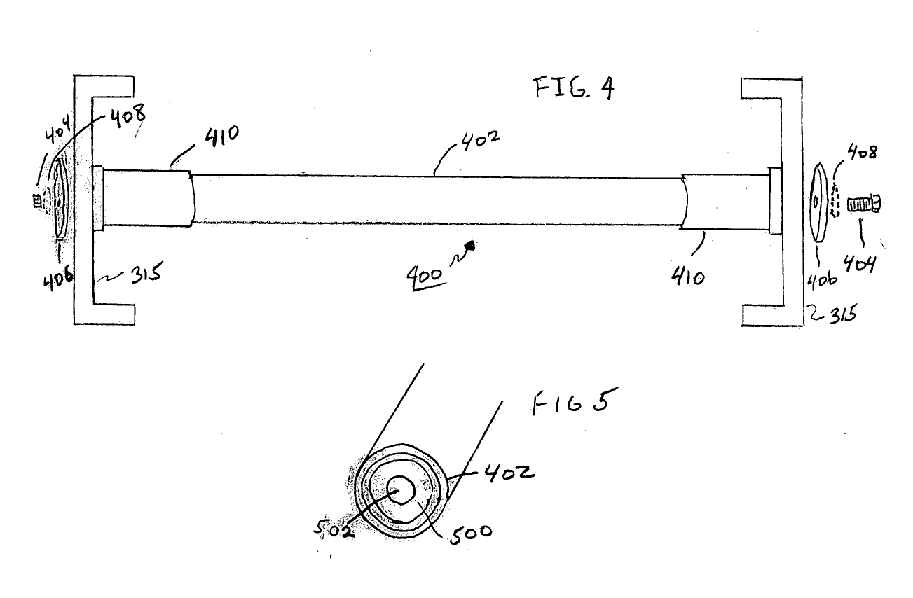

FIG. 4 generally depicts a hinge arrangement 400 which couples first side 301 to second side 305 in accordance with the invention. For the sake of explanation, hinge arrangement 400 is only shown coupled to second side 305, and thus extended side rails 315, in FIG. 4; first side 301 with top step 312 is not shown in FIG. 4. As shown in FIG. 4, a tubular stock 402 having a length substantially equal to a distance from the insides of side rails 315 is used to contain a shaft 500. In the preferred embodiment, the tubular stock 402 is a conduit having a diameter of one-half (½) inch. One skilled in the art will appreciate that any size or type of tubular stock or conduit can be implemented without departing from the spirit and scope of the invention.

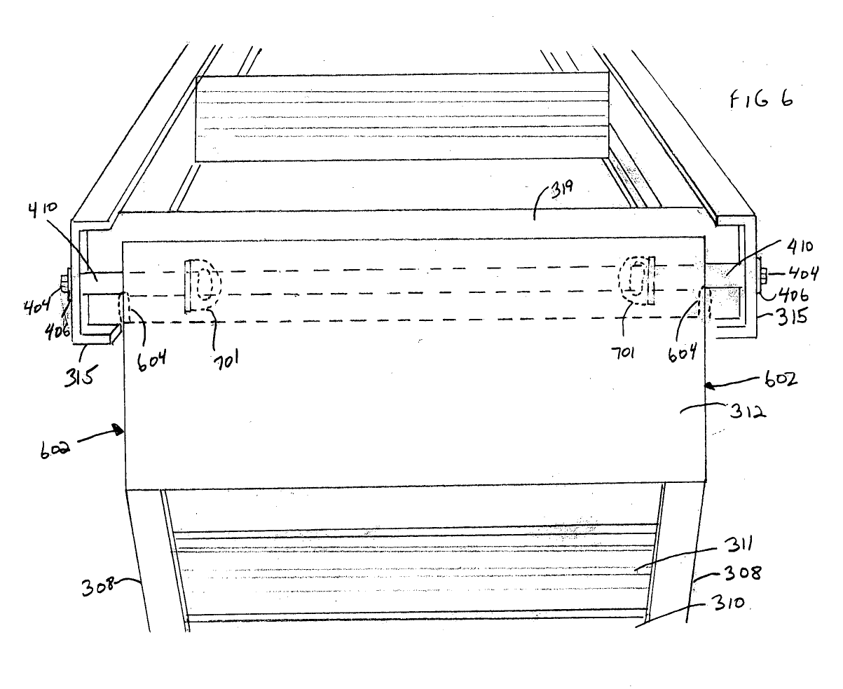

A side view of conduit 402 and a shaft 500 is shown in FIG. 5. In the preferred embodiment, shaft 500 is a solid shaft having a threaded opening 502 on each end thereof and having a length substantially equal or slightly shorter than conduit 402. Bolts 404 matching the threads of threaded opening 502 and washers 406, 408 are used to securely couple conduit 402 and shaft 500 to side rails 315 of second side 305 in accordance with the invention. The size and/or thread size of bolts 404 and the number and/or size of washers 406, 408 can be varied without departing from the spirit and scope of the invention.

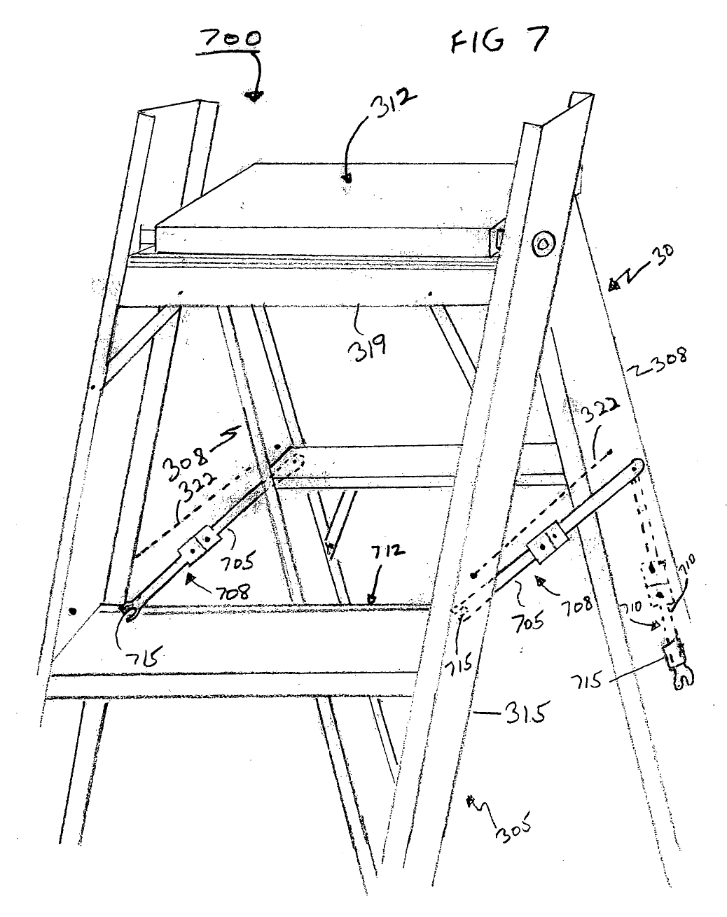

Also shown in FIG. 4 are spacers 410. Spacers 410 substantially prohibit top step 312 from sliding along conduit 402 when hinge arrangement 400 is completely configured as shown in FIG. 6. Referring to FIG. 6, spacers 410 each have a length substantially equal to a distance from the sides 602 of top step 312 of the first side 301 to set of side rails 315 of second side 305. Spacers 410 are used to substantially prohibit top step 312 from sliding along conduit 402. As also shown in FIG. 6, conduit 402 extends through sides 602 of the top step 312. In an alternate embodiment, conduit 402 could extend through brackets 701 coupled to the top step 312 instead of (or additionally) extending through sides 602 of top step 312. Notches 604 are included in step 319 to accommodate sides 602 of top step 312 when ladder 300 is in the closed position. If notches 604 were not included in ladder 300 in accordance with the invention, step 319 and sides 602 of top step 312 would connect before ladder 300 was fully closed and such connection would thus prevent ladder 300 from fully closing.

FIG. 7 generally depicts a ladder 700 having improved mobility in accordance with an alternate embodiment of the invention. As shown in FIG. 7, ladder 700 is substantially ladder 300 of FIG. 3 except that ladder 700 additionally includes brackets 705. For those users who desire a ladder which maintains the A-frame position but still has improved mobility because side 301 is narrower than side 305, brackets 705 can be moved to the closed position as shown by arrow 708. In the preferred embodiment, brackets 705 include an opening 715 which is coupled to a lip 712 of step 318. Although not specifically shown, step 318 could include notches and brackets 705 could be coupled to step 318 at the notches. As one skilled in the art will appreciate, other means of coupling brackets 705 to step 318 in the closed position 708 could be contemplated without departing from the spirit and scope of the invention.

As further shown in FIG. 7, brackets 705 can equally be implemented in the open position as shown by arrow 710. In this position, ladder 700 has all of the improved mobility characteristics as ladder 300. Also, in this position, it is desirable to keep brackets 705 from interfering with the improved mobility of ladder 700. In the preferred embodiment, a piece of Velcro 715 or the like on each of brackets 705 could be beneficially implemented to maintain brackets 705 against sides 308. As one skilled in the art will appreciate, brackets 705 could be replaced with a single bracket (for example, between steps 311 and 318) without departing from the spirit and scope of the invention.

The present invention has been described above in terms of a presently preferred embodiment and alternate embodiments so that an understanding of the present invention can be conveyed. There are, however, many configurations not specifically described herein but with which the present invention is applicable. The present invention should not therefore be seen as limited to the particular embodiment described therein, but rather, it should be understood that the present invention has applicability to ladders generally. All modification, variations, or equivalent arrangements that are within the scope of the attached claims should therefore be considered to be within the scope of the invention.

We claim:

1. A ladder comprising:
a first side having a top step coupled thereto; and
a second side including a set of side rails coupled together, the second side coupled to the top step of the first side via a hinge arrangement, the hinge arrangement including a shaft coupled to the top step of the first side and the set of side rails of the second side.

2. The ladder of claim 1, wherein the first side is narrower than the second side.

3. The ladder of claim 2, wherein the first and second sides comprise a set of side rails coupled together.

4. The ladder of claim 3, wherein the set of side rails for the second side extends beyond the height of the top step.

5. The ladder of claim 3, wherein the side rails are coupled together via steps or rungs which are substantially perpendicular to the side rails.

6. The ladder of claim 3, wherein the top step of the first side is positioned between the set of side rails of the second side.

7. The ladder of claim 6, wherein the hinge arrangement comprises a tubular stock having a length substantially equal to the distance separating the set of side rails of the second side.

8. The ladder of claim 1, wherein the hinge arrangement further comprises a shaft extending through the sides of the top step of the first side and the set of side rails of the second side.

9. The ladder of claim 8, where the hinge arrangement further comprises at least two spacers each having a length substantially equal to a distance from the sides of the top step of the first side to the set of side rails of the second side.

10. The ladder of claim 1, wherein the hinge arrangement further comprises a shaft extending through brackets coupled to the top step of the first side and the set of side rails of the second side.

11. The ladder of claim 10, wherein the hinge arrangement further comprises at least two spacers each having a length substantially equal to a distance from the brackets coupled to the top step of the first side to the set of side rails of the second side.

12. The ladder of claim 1, wherein the first side includes a top step securely coupled thereto.

13. The ladder of claim 1, wherein the first and second sides are supported by at least one chain.

14. The ladder of claim 13, wherein the first and second sides are supported by at least one bracket.

15. A ladder comprising:
a first side having a top step coupled thereto; and
a second side including a set of side rails coupled together, the second side being wider than the first side and coupled to the top step of the first side via a hinge arrangement, the hinge arrangement including a shaft coupled to the top step of the first side and the set of side rails of the second side, wherein the shaft has a length of at least the distance separating the set of side rails of the second side.

16. The ladder of claim 15, wherein the first and second sides comprise a set of side rails coupled together.

17. The ladder of claim 16, wherein the hinge arrangement further comprises a shaft extending through the sides of the top step of the first side and the set of side rails of the second side.

18. The ladder of claim 16, wherein the hinge arrangement further comprises a shaft extending through brackets coupled to the top step of the first side and the set of side rails of the second side.

19. The ladder of claim 15, wherein the first and second sides are supported by at least one chain and at least one bracket.

20. A ladder comprising:
a first side having a top step coupled thereto; and
a second side including a set of side rails coupled together, the second side coupled to the top step of the first side via a hinge arrangement, the hinge arrangement including a shaft coupled to the top step of the first side and the set of side rails of the second side, wherein the first and second sides are supported by at least one chain and at least one bracket.
